(19) United States
(12) Patent Application Publication
(10) Pub. No.: US 2018/0204552 A1
(43) Pub. Date: Jul. 19, 2018

(54) Damper Bar Adjustment Mechanism For Keyboard Percussion Instrument

(71) Applicant: Stephen J. Cole, Arcata, CA (US)

(72) Inventor: Stephen J. Cole, Arcata, CA (US)

(21) Appl. No.: 15/409,018

(22) Filed: Jan. 18, 2017

(51) Int. Cl. G10D 13/08

(52) U.S. Cl. CPC G10D 13/085

(57) ABSTRACT

A keyboard percussion instrument (100) generates sounds when keys (130) or other such members are struck. A movable damper bar (140) is brought into contact with the keys to artistically shorten their ringing duration. When pressed, a pedal (145) removes the damper bar from contact with the keys. When the pedal is released, a spring (1010) urges the damper bar into contact with the keys. The damper bar is supported by a pair of arms (165) that pivot about pivot points (800) at the ends of movable posts (520) that extend from a pair of pivot height adjusting mechanisms (175). Each pivot height adjusting mechanism has two adjusting screws. A first screw (510) urges a post to move up or down and a second screw (565) fixes the post in position when tightened. Adjusting the height of pivot points provides control over damping of key vibrations.

### BACKGROUND

### Prior Art

A keyboard percussion instrument such as a marimba or vibraphone comprises a plurality of keys that are held in a frame. A user wields at least one mallet, striking various keys to produce musical sounds. When struck, each key produces a fundamental frequency that depends on the length of the key. The keys are supported in the frame in such a way that, when they are struck with an impulsive force, the ringing sound made by striking a key can last for a period of seconds. A user typically wishes to control, i.e., shorten, the duration of the ringing sound. The ringing sound is shortened with the use of a damper bar. A damper bar comprises an assembly including a rigidly supported felt strip or other material that is urged against one or more keys by a foot-pedal-controlled mechanism. To make a musical sound, a user presses a foot-pedal downward, removing the damper bar from contact with the keys. The user then strikes the top surface of a key with a mallet, causing the key to vibrate or ring. When the user wishes to stop the ringing sound, the foot pedal is released, urging the damper bar back into contact with the underside of a key to dampen the ringing sound.

In general, it is desirable for a damper bar to contact all the keys of an instrument simultaneously. This permits a user to dampen the ringing of all keys at the same time. Some users may want other scenarios, such as damping the treble keys first followed by the bass keys, or vice-versa. In the past, adjustment of the damping mechanism to obtain these three damping styles, i.e. all keys simultaneously, treble first, and bass first, required tools or even bending of parts of the mechanism that supported the damper bar. The need for using tools or bending parts of the damping mechanism prevented rapid adjustment of the damping mechanism, as is sometimes desirable between pieces of music during a musical performance. For example, a first musician may prefer uniform damping of all keys when the damping mechanism pedal is released, and a second musician, who is playing in the same musical set, may prefer damping bass keys first. In the past, it was impractical to accommodate the styles of both musicians during a musical performance. Even during normal maintenance of an instrument, the use of tools and bending of mechanical parts to adjust damping were at best inconvenient.

Stevens, in U.S. Pat. No. 8,049,089 B2 (2011) shows a keyboard percussion instrument having a damper bar. Stevens's damper bar is urged against the underside of his keys in response to the motion of a foot pedal and lever mechanism. Stevens provides the above three damping scenarios, i.e., damping all keys simultaneously, or progressively damping keys from one end of an instrument to the other, however he requires the use of tools to accomplish this.

Stevens provides two methods for adjusting and selecting damper bar performance through two damper bar mounting designs. In a first design, a damper bar (322 in FIGS. 4 and 5) is joined to a damper support arm (334b) by a pair (one at each end of the damper bar) of elastic elements (338). Fastening elements (339) are slidably inserted through the elastic elements and secure the damper bar to the damper support so that when a fastening element is tightened, the elastic element is compressed and the damper bar rests closer to the support arm. By selectively tightening the fastening elements at each end, any of the three damping scenarios can be achieved.

In a second design, two fastening elements (339a, 339b in FIG. 5A) additionally permit rotational adjustment of the damping bar about the long axis of the damping bar.

While Stevens provides adjustment of the damping bar to accomplish various damping scenarios, his system does not lend itself to easy and fast adjustment. I.e., it is necessary to somehow access fasteners (339) from within the end of his damping bar (322). This adjustment may need to be repeated after long use of the instrument. Thus it is difficult and awkward if sequential users of an instrument had different damping preferences. In either case, it is necessary to use tools and reach into the structure of the instrument to make the required adjustments between users.

### SUMMARY

I have discovered a method and apparatus that allows rapid adjustment of the height of a damping bar with respect to the underside of the keys in a keyboard percussion instrument. The height of the damping bar is independently adjustable at both ends, thus allowing selection of all three damping scenarios, i.e., all keys at once, the treble keys first, or the bass keys first. My mechanism independently supports each end of the damping bar and the height at each end is independently adjustable with thumbscrews, i.e., no tools are required. My apparatus is easily reached and quickly operated without reaching into the structure of the instrument with tools. The same adjustment of the damper bar location can be achieved by using one height adjustment mechanism at either the bass end of the instrument or the treble end instead of allowing the adjustment at both ends.

### DRAWING FIGURES

FIG. 1 is a perspective schematic view showing selected portions of a keyboard percussion instrument according to one aspect of an embodiment.

FIG. 2 is a perspective end view of a damper bar according to one aspect.

FIG. 3 is a perspective side view of a pivot arm according to one aspect.

FIG. 4 is a perspective view showing attachment of a pivot arm to a damper bar.

FIG. 5 is a perspective front view showing components of a pivot height adjusting mechanism.

FIGS. 6A, 6B, and 6C are top views showing assembly and operation of a pivot height adjusting mechanism according to one aspect.

FIG. 7 is a side view showing attachment of a pivot height adjusting mechanism to a frame member of a keyboard percussion instrument.

FIGS. 8 and 9 are perspective views showing left and right-hand pivot adjusting mechanisms, pivot arms, and a damper bar mounted in a keyboard percussion instrument and ready for use.

FIG. 10 is a perspective skeletal view a damping bar and associated mechanisms in place in a keyboard percussion instrument.

### REFERENCE NUMERALS

| | | | |
|---|---|---|---|
| 100 | Marimba or vibraphone instrument | 105 | Leg |
| 110 | Leg | 115 | Cross member |
| 120 | Cross member | 125 | Frame member |
| 130 | Key | 135 | Support |
| 140 | Damper bar | 145 | Foot pedal |
| 150 | Arm | 155 | Hinge |
| 160 | Connecting member | 165 | Pivot arm |
| 170 | Hole | 175 | Pivot height adjusting |
| | | | mechanism |
| 200 | Top layer | 205 | Bottom layer |
| 300 | Hole | 400 | Fastener |
| 500 | Body portion | 505 | Adjusting screw |
| 510 | Thumbwheel | 515 | Nut |
| 520 | Post | 522 | Channel |
| 524 | Inner surface | 525 | Opening |
| 530 | Hole | 535 | Hole |
| 545 | Hole | 550 | Cover plate |
| 555 | Hole | 560 | Hole |
| 565 | Tightening thumbscrew | 570 | Hinge point screw |
| 700 | Hole | 705 | Fastener |
| 800 | Fastener | 1000 | Support beam |
| 1005 | Attachment fixture | 1010 | Spring |
| 1015 | Screw | 1020 | Nut |
| 1025 | Hole | | |

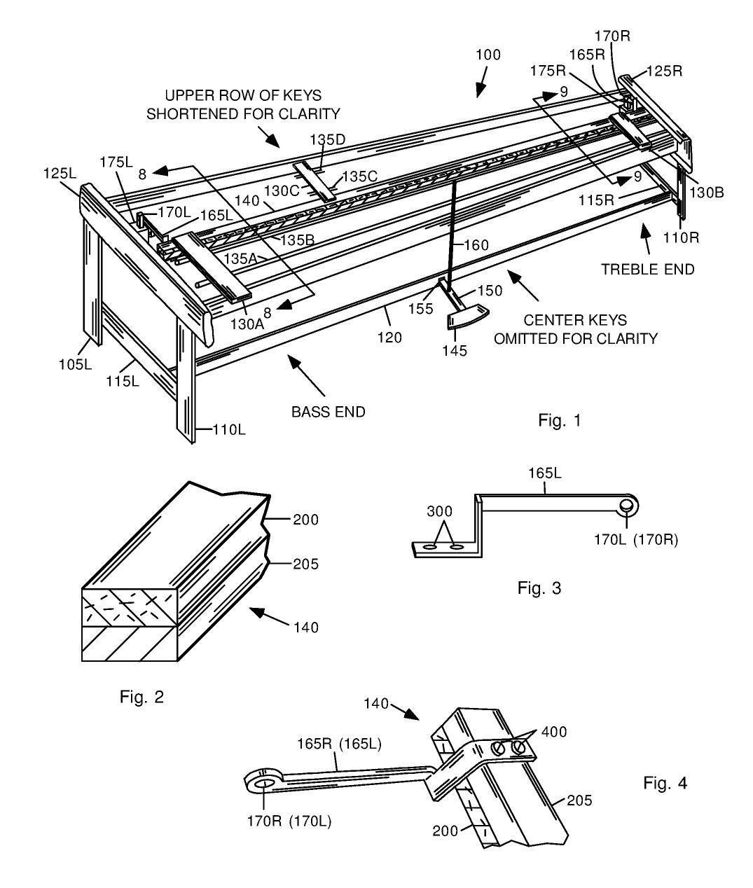

### First Embodiment—Marimba With Adjustable Damper Pivots—FIG. 1—Overview

FIG. 1 is a perspective schematic view showing selected portions of a keyboard percussion instrument, such as a marimba. An instrument 100 comprises a stand having a plurality of legs 105L, 110L, 110R, and 105R (not shown in this view) that are rigidly secured together by cross members 115L and 115R (hereafter 115L and R), respectively. A third cross member 120 is rigidly secured to cross members 115L and R as shown. A pair of frame members 125L and R are secured to legs 105L, 110L and R (not shown in this view), and 110R, respectively. A known mechanism (not shown) is provided to raise or lower frame members 125L and R with respect to legs 105L, 105R, 110R, and 110L. This allows players of various heights to comfortably play the instrument. Various stationary components and other cross members are secured to frame members 125L and 125R in order to form a working instrument.

A plurality of keys 130A, 130B, and 130C rest on a plurality of supports 135A, 135B, 135C, and 135D. Only three keys and portions of four supports are shown in this view. In practice, there are two full rows of keys and two sets of supports. The keys are arranged with lower notes near a bass end and higher notes near a treble end of instrument 100. When the top side of any key is struck with a mallet or other object, the key vibrates and produces audible sounds.

A movable damper bar 140 is positioned so that the top surface of bar 140 is springably urged by a spring 1010 (FIG. 10) into contact with or against the underside of all keys 130A, 130B, etc. in both rows. This is the normal position of damper bar 140. In this position, damper bar 140 prevents any key with which it is contact from ringing.

A foot pedal 145 is pivotally secured to cross member 120 by an arm 150 and a hinge 155. A connecting member 160, such as a rod, chain, rope, or strap, is secured to arm 150 at a first end and damping bar 140 at a second end. Pedal 145, arm 150, hinge 155, and connecting member 160 are normally positioned at the center of damper bar 140.

A pair of pivot arms 165L and R are secured to damper bar 140 at a first end. The second end of arms 165L and R terminate in pivot holes 170L and R, respectively. Pivot holes 170L and R are joined to pivot height adjusting mechanisms 175L and R. Pivot arms 165L and R are made of metal, plastic, reinforced plastic, or wood. These components are described in more detail below.

Damper Bar and Pivot Arms—FIGS. 2 Through 4.

FIG. 2 is a perspective end view of damper bar 140. Bar 140 typically comprises two layered sections. A top layer 200 is made of felt, a fluid-filled bladder, or other material. Layer 200 preferably is slightly compressible so as not to generate unwanted sounds when contacting the underside of keys 130A, 130B, etc.

A bottom layer 205 of bar 140 is made of a rigid material such as metal, hardwood, or reinforced plastic. Layers 200 and 205 are securely attached to one another by adhesive or other fastening means.

FIG. 3 is a perspective view of a pivot arm 165L. Pivot arm 165R is a mirror image version of arm 165L. Arms 165L and R include a pivot hole 170L (170R) and an angled section with one or more holes 300 that are used to accommodate fasteners that secure arm 165L (165R) to damper bar 140.

FIG. 4 is a perspective view of the underside of the right-hand end of damper bar 140 showing attachment of pivot arm 165R to bar 140 using fasteners 400, such as screws, bolts, rivets, etc. Instead of fasteners, pivot arms 165R and L can be secured to bar 140 by adhesives or other means. Pivot arms 165L and R are secured near the ends of damper bar 140 in order to permit their connection to pivot height adjusting mechanisms 175L and R.

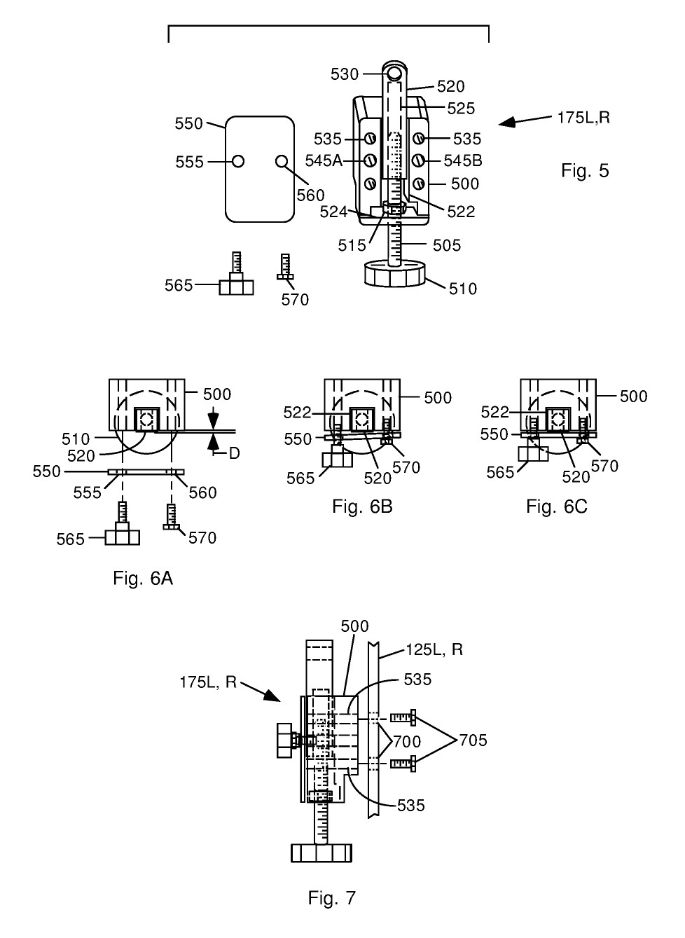

Pivot Height Adjusting Mechanisms—Construction—FIGS. 5 Through 6C.

FIG. 5 is a perspective view of the various components comprising pivot height adjusting mechanisms 175L and R. These two mechanisms are identical in this disclosure, although they can optionally be mirror images of one another. Their different designations refer to their placement in instrument 100.

FIG. 6A is an exploded top view of a pivot height adjusting mechanism 175. A pivot height adjusting mechanism (mechanism) 175 comprises a body portion 500, an adjusting thumbscrew 505 with a thumbwheel 510 fixedly secured to screw 505, a nut 515 secured to screw 505, and a post 520. Post 520 slidably moves within a channel 522 in body 500. Post 520 further includes an axial opening 525 with internal threads that rotatably engage threads on screw 505, and a pivot hole 530. Nut 515 is secured and fixed in position on screw 505. It acts as a thrust bearing against the lower, inner surface 524 of body 500 and rotates with screw 505. Post 520 extends and retracts from body 500 as screw 505 is turned. Post 520 is generally rectangular in cross-section, although it can have another cross-sectional shape, such as circular, hexagonal, or the like. A plurality of holes 535 are provided for mounting mechanism 175 to frame members 125L and R. Two holes 545A and B are used in the operation of mechanism 175, as explained below.

A cover plate 550 contains at least two holes 555 and 560 to permit the passage of a tightening thumbscrew 565 and a hinge-point screw 570 through holes 555 and 560 and into holes 545A and 545B (FIG. 5), respectively. Post 520 is sized to extend a small distance “D” (FIG. 6A) beyond a front face of body 500. Distance D is on the order of 0.5 mm, although other distances can be used. Hinge-point screw 570 provides an anchor for cover plate 550 and helps urge cover plate 550 against post 520 when thumbscrew 565 is tightened. Body portion 500 and cover plate 550 can be made of wood, metal, or plastic.

FIGS. 6B and 6C are top views showing the installation and adjustment of cover plate 550, thumbscrew 565, and hinge pin screw 570 in body 500 of mechanism 175. In FIG. 6B, thumbscrew 565 and hinge pin screw 570 are installed loosely into body 500 so that cover plate 550 does not contact the exposed side of post 520. Hinge pin screw 570 is then screwed into body 500 until cover plate 550 just begins to lightly graze the exposed side of post 520. At this point, post 520 is free to slidably move up and down in channel 522 of body 500.

FIG. 6C is a top view showing the position of various parts when thumbscrew 565 is fully tightened. Hinge pin screw 570 provides a fulcrum about which cover plate 550 rotates. Tightening thumbscrew 565 urges cover plate 550 to rotate until plate 550 is urged tightly against the exposed surface of post 520. Thus post 520 is pressed and locked in position between cover plate 550 and the innermost surface of channel 522.

Body 500 and post 520 of mechanism 175 are made of metal, reinforced plastic, or hardwood. Nut 515, screw 505 and cover plate 550 are made of metal, although other materials can be used. Screws 565 and 570 are made of metal, although other materials can be used. Thumbscrews 510 and 565 have knurled finger grips to permit fingertip adjustment.

Pivot Height Adjusting Mechanisms—Operation—FIGS. 5 Through 6C.

Pivot height adjusting mechanism 175 is operated by first loosening thumbscrew 565 as shown in FIG. 6B, permitting post 520, and therefore pivot point 530, to move up and down within channel 522 of body 500. Thumbscrew 505 is turned until the desired height of pivot point 530 relative to the top of body 500 is reached, and then thumbscrew 565 is tightened until post 520 is immovably pressed by friction between plate 550 and the innermost surface of channel 522. It is also understood that thumbscrew 565 could be left is one position such that a slight amount of pressure is exerted on post 520. This slight pressure will be enough to hold post 520 in position but will still allow thumbscrew 505 to be rotated thus raising or lowering post 520. This can be used to advantage when a rapid raising or lowering of the pivot point 530 is required during the playing of one or several pieces of music.

Pivot Height Adjusting Mechanisms—Installation—FIGS. 7 Through 9.

FIG. 7 is a side view showing the attachment of mechanisms 175L and R to frame members 125L and R. A plurality of holes 700 are bored through frame members 125L and R. Holes 700 are positioned to match holes 535 in body 500 of mechanism 175L and R. A plurality of fasteners 705 are inserted through holes 700 and tightly secured in body 500, thereby securing mechanisms 175L and R to frame members 125L and R.

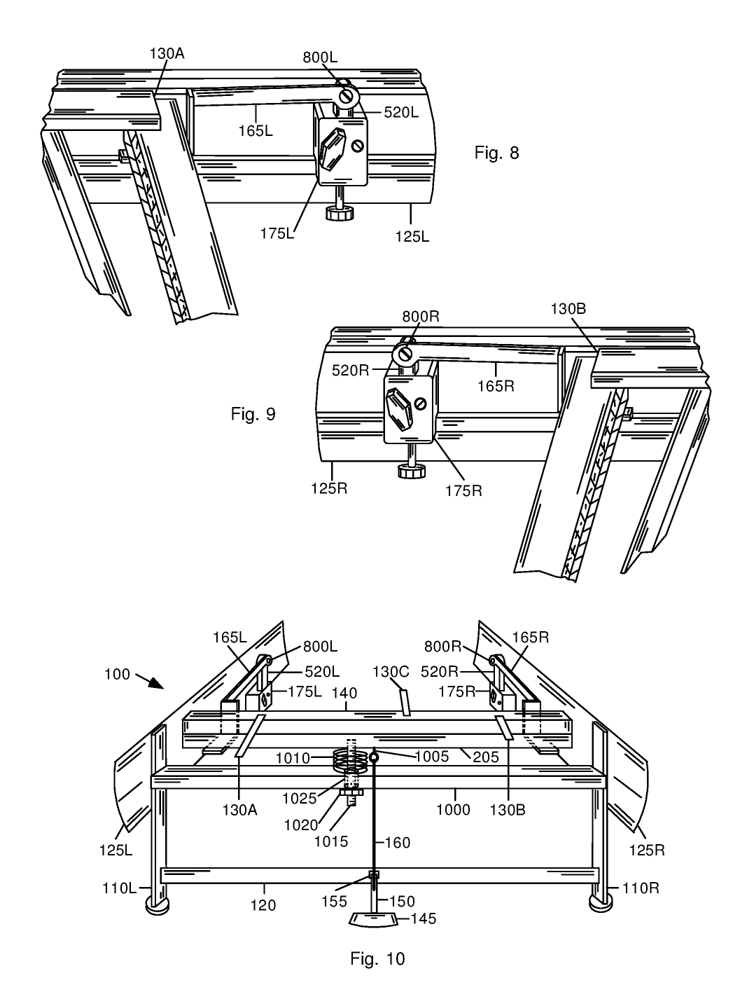

FIGS. 8 and 9 are perspective views showing frame members 125L and R with mechanisms 175L and R secured thereto. Arms 165L and R are secured to damper bar 140 at a first end as described above. A pair of fasteners 800L and R rotatably secure arms 165L and R via holes 170L and R to posts 520L and R, respectively, at their opposite ends. Fasteners 800L and R are screws or other fasteners that are secured in holes 530 of posts 520 (FIG. 5), but are loose enough to permit arms 165L and R to rotate freely thereon.

Pivot Height Adjusting Mechanisms—Operation—FIG. 10.

FIG. 10 is a perspective skeletal view of the instrument shown in FIG. 1, showing details of operation and positioning of the components of one aspect of a damping mechanism. A support beam 1000, an attachment fixture 1005, a spring 1010, a height-limiting screw 1015, and a nut 1020 are shown in this view. The support bar may be a separate member or the support bar may consist of one or more structures which support the keys of the instrument. Attachment fixture 1005 is secured to the underside of damper bar 140. Connecting member 160 is secured to fixture 1005 and arm 150, as described. Pedal 145 normally rests about 4 cm above the lower ends of posts 110L and R. Spring 1010 is sized to urge the top surface of damper bar 140 into contact with keys 130A, B, C, etc. when pedal 145 is at rest, i.e. not urged downward. Height-limiting screw 1015 passes slidably through a hole 1025 in beam 1000. At its upper end, screw 1015 is secured into the bottom part 205 of damper bar 140. Nut 1020 is screwed downward on screw 1015 until the top surface of damper bar 140 is gently urged against the lower surface of keys 130A, B, C, etc.

Normally damper bar 140 is urged upward by spring 1010 so as to prevent any key from ringing when it is struck by a user with a mallet. When pedal 145 is pressed downward by the user's foot, connecting member 160 urges damper bar 140 downward, away from contact with keys 130A, B, C, etc. in order to permit ringing of any key that a user strikes. Fixture 1005, spring 1010, and screw 1015 are normally located at the center of damper bar 140.

In the prior art, the pivot points on damper bar arms were not readily adjustable. It is necessary to adjust these in order to ensure proper operation of the damping mechanism. I.e., damping of all keys simultaneously, or damping of the bass or treble keys first as may be required by a particular user. In some cases, the arms that supported the damper bar were manually bent to accommodate these preferences. The present apparatus permits adjustment of the damping mechanism through manual turning of thumbscrews. Thus this adjustment can be done quickly, without bending internal parts of an instrument, and without the use of tools.

The pivot points can be set at equal heights with respect to the damping bar, or they can be set at unequal heights. When the pivot point at the treble end of an instrument is higher than that at the bass end of the instrument, high notes at the treble end are damped before those at the bass end when the damping pedal is released.

Steps in Adjusting Pivot Points.

The following steps are used to adjust the height of pivot fasteners 800L and 800R, and therefore the pivot points of arms 165L and 165R. This adjustment is made when it is desired to take control over the damping of sounds produced by a keyboard percussion instrument. The adjustment is used to fine-tune operation of the damping mechanism, as described above, i.e., when it is desired to cause all keys to be damped simultaneously, or to be damped at one end of a keyboard before the other end.
1. Pedal 145 is released.
2. Mechanisms 175L and R are adjusted so that the pivot points defined by the location of fasteners 800L and R are at the same height relative to bodies 500 of mechanisms 175L and R.
3. Nut 1020 on screw 1015 is adjusted so that the upper surface of damper bar 140 just contacts one of keys 130A or B.
4. If damper bar 140 contacts keys 130A and B with the same force, determined by the relative upward displacement of keys 130A and B, the pivot point adjustment process is complete.
5. If damper bar 140 contacts key 130A, but not key 130B, then the pivot point defined by fastener 800R is raised by adjusting mechanism 175R until damper bar 140 contacts keys 130A and B with equal force.
6. If damper bar 140 contacts key 130B, but not key 130A, then the pivot point defined by fastener 800L is raised by adjusting mechanism 175L until damper bar contacts keys 130A and B with equal force.
7. Next nut 1020 on screw 1015 is adjusted so that the upper surface of damper bar 140 is urged against all keys 130A, B, C, etc. with the same force. This completes the damper bar adjustment.

### CONCLUSION, RAMIFICATIONS AND SCOPE

I have devised an improved method and mechanism for adjusting the damping of musical sounds emitted by a keyboard percussion instrument after a key has been struck. This is accomplished by adjusting the height of pivot points of a damping bar in a keyboard percussion instrument. My mechanism requires no tools; instead the user makes all adjustments manually using thumbscrews. The thumbscrews are easily reached from outside the instrument so that the height of the damping bar pivot points can be rapidly adjusted, i.e., between musical performances or between music pieces. A pivot point at one end of a damping bar can be fixed in position, while the pivot point at the opposite end of the damping bar is adjustable.

Instead of manually urging thumbscrews to raise and lower the pivot point, an electric or pneumatic motor can be used. While the examples discussed relate to marimbas and vibraphones, the principles of my system apply to all keyboard percussion instruments that employ damping of vibrations that have been induced in vibrating parts including keys, bars, and even strings.

Thus the scope should be determined by the appended claims and their legal equivalents, rather than the examples and particulars given.

1. A keyboard percussion instrument, comprising:
a plurality of frame members,
a plurality of supports secured to said frame members,
a plurality of keys that rest on said supports, each of said keys having a top side and an underside,
a damping bar having first and second ends and arranged to periodically come into contact with said undersides of said keys,
at least one pivot height adjusting mechanism secured to a first of said frame members,
said pivot height adjusting mechanism comprising a housing, a movable post with a pivot point, and an adjusting thumbscrew for urging said post up and down,
a plurality of pivot arms, each of said pivot arms having first and second ends, said first end of each of said pivot arms being secured to said first end of said damping bar and said second end of each of said pivot arms being secured to said pivot point of said movable post,
a spring secured to one of said frame members and arranged to urge said damping bar into contact with said undersides of said keys,
a pedal hingeably secured to one of said frame members,
a connecting member having a first end connected to said pedal and a second end connected to said damping bar, so that when said pedal is actuated, said damping bar is removed from said contact with said undersides of said keys, and when said pedal is released, said damping bar is urged by said spring into contact with said undersides of said keys,
whereby when said damper bar is urged to move up by said spring or down by said pedal, said damper bar and said pivot arms pivot about said pivot point, thereby causing said damper bar to contact said underside of said keys in a predetermined manner as said pedal is released.

2. The instrument of claim 1 wherein said movable post has two pivot points and the height of only one of said pivot points is adjustable through the use of said adjusting thumbscrew.

3. The instrument of claim 1, further including a second pivot height adjusting mechanism secured to a second of said pivot arms, said second end of said damping bar, and a second of said frame members.

4. The instrument of claim 1 wherein said instrument has a plurality of bass keys and a plurality of treble keys and said pivot points of said plurality of arms are adjusted to urge said damping bar into contact with said underside of said keys in a predetermined fashion in order to provide damping selected from the group consisting of damping all keys simultaneously, damping of said treble keys before said bass keys, and damping of said bass keys before said treble keys.

5. The instrument of claim 1, further including a tightening thumbscrew for pressing and frictionally securing said post at a predetermined position in said mechanism when said second thumbscrew is tightened.

6. The instrument of claim 1, further including a hinge point screw and wherein said cover plate includes first and second holes, said tightening thumbscrew passes through a first of said holes and said hinge point screw passes through said second of said holes, so that when loosely secured against said cover plate, said hinge point screw provides an anchor for said cover plate when said tightening thumbscrew is tightened.

7. The instrument of claim 1 wherein said body portion, said post, and said cover plate of said pivot height adjusting mechanism are made of materials selected from the group consisting of plastic, metal, and wood.

8. A method for adjustably positioning a damper bar in a keyboard percussion instrument, comprising:
providing a damper bar having first and second ends,
providing a pivot arm having first and second ends, said first end of said pivot arm being secured to said first end of said damper bar, and said second end of said pivot arm including a hole,
providing a pivot point height adjusting mechanism with a height-adjusting thumbscrew, said mechanism including a post extending from said mechanism, said post including a hole at one end distal from said mechanism, and said post adjustably extending from said mechanism a predetermined amount when urged by said height-adjusting thumbscrew,
providing a fastener,
joining said pivot hole of said pivot arm to said hole in said post using said fastener to provide a rotatable pivot point,
whereby when said damper bar is urged to move, said damper bar and said pivot arm pivot about said fastener at a height determined by said height adjusting thumbscrew.

9. The method of claim 8, further providing a second pivot point height adjusting mechanism, a second pivot arm secured to said damper bar at said second end of said damper bar, said hole in said second end of said pivot arm being rotatably joined to said hole in said post by said fastener, whereby said first and said second ends of said damper bar pivot about said pivot points of said first and said second pivot point height adjusting mechanisms.

10. The method of claim 8, further including providing a keyboard percussion instrument having frame members, including at least a first frame member to which said pivot height adjusting mechanism is secured.

11. The method of claim 10, further including:
providing a pedal secured to a second of said frame members,
providing a connecting member connecting said pedal to said damper bar,
providing a spring secured to a third of said frame members,
whereby when said pedal is actuated, said damping bar and said pivot arm pivot about said fastener in a first direction, and when said pedal is released, said damping bar and said pivot arm pivot about said fastener in a second direction, thereby raising and lowering said damping bar.

12. The method of claim 8, further including a keyboard instrument having a plurality of keys, each having upper and lower surfaces, said damper bar having an upper surface and positioned by said pivot points so that when said pedal is released, said upper surface of said damper bar contacts said lower surface of said keys, thereby damping vibrations of said keys.

13. The method of claim 12 wherein said pivot points are adjusted so that when said pedal is released, said upper surface of said damper bar contacts said lower surface of a plurality of said keys selected from the group consisting of bass keys, treble keys, and all keys.

14. The method of claim 8, further including providing a hinge point screw wherein said cover plate includes first and second holes, said tightening thumbscrew passing through a first of said holes and said hinge point screw passing through said second of said holes, so that when loosely secured against said cover plate, said hinge point screw provides an anchor for said cover plate when said tightening thumbscrew is tightened.

15. A damping mechanism for a keyboard percussion instrument having keys with underside surfaces, comprising:
a damper bar having upper and lower surfaces and first and second ends,
a plurality of pivot arms having first and second ends, said first ends fixedly secured to said first and said second ends at said lower surface of said damper bar, respectively, each pivot arm being rotatably secured to a pivot point at said second end,
an adjusting thumbscrew and a post for enabling the height of said pivot points to be adjusted by adjusting the height of said pivot points, said post being fixedly secured by means comprising a tightening thumbscrew and a cover plate,
whereby when said tightening thumbscrews and said cover plates are loosened, turning said adjusting thumbscrews raises or lowers said pivot points, and when said tightening thumbscrews are tightened said cover plates are pressed against said posts and thereby fixedly securing said pivot points.

16. The damping mechanism of claim 15, further including pedal means for raising and lowering said damper bar so that when said pedal is actuated, said damper bar is removed from contact with said keys, and when said pedal is released said damper bar is urged into contact with said underside surface of said keys.

17. The damping mechanism of claim 16 wherein said pivot point height adjusting means is arranged to urge said damper bar into contact with said undersides of a plurality of said keys selected from groups consisting of bass keys, treble keys, and all keys.

18. The damping mechanism of claim 15 wherein said tightening thumbscrew is tightened such that said adjusting thumbscrew can raise or lower said post with increased effort when compared to that required when said tightening thumbscrew is not tightened, yet said post will remain in a predetermined position while said instrument is in use.

19. The damping mechanism of claim 15, further including a hinge point screw and wherein said cover plate includes first and second holes, said tightening thumbscrew passing through a first of said holes and said hinge point screw passing through said second of said holes, so that when loosely secured against said cover plate, said hinge point screw provides an anchor for said cover plate when said tightening thumbscrew is tightened.

20. The damping mechanism of claim 15 wherein said pivot arms are made from materials selected from the group consisting of metal, plastic, reinforced plastic, and wood.
